(19) United States
(12) Patent Application Publication
(10) Pub. No.: US 2005/0169491 A1
(43) Pub. Date: Aug. 4, 2005

(54) Pliant coating for hearing aid earmolds

(75) Inventors: William G. Pitt, Orem, UT (US); Peter D. Busselberg, Orem, UT (US)

Correspondence Address: ALAN J. HOWARTH, P.O. BOX 1909, SANDY, UT, 84091-1909, US

(73) Assignee: Brigham Young University, Provo, UT (US)

(21) Appl. No.: 10/506,928

(22) PCT Filed: Mar. 7, 2003
(86) PCT No.: PCT/US03/07246

Related U.S. Application Data
(60) Provisional application No. 60/362,667, filed on Mar. 7, 2002.

(51) Int. Cl. B32B 27/00; B32B 27/30; H04R 25/00; B05D 3/00

(52) U.S. Cl. 381/322; 428/522; 264/241; 427/401; 428/500; 381/328

(57) ABSTRACT

Failure of the acoustic seal in “in-the-ear” hearing aid earmolds is a principle cause of acoustic feedback. The ongoing development of smaller hearing aids with close proximity between the hearing aid microphone and receiver mandates the highest quality earmold fit. This invention relates eliminates the feedback problem by placing a soft, pliant, and durable hydrogel coating (16) on the earmold (18) The coating swells after the hearing aid is inserted and, thus, seals off any pathways for acoustic feedback. After removal at night, the earmold dries and returns to its smaller size, ready for insertion the next day.

### BACKGROUND OF THE INVENTION

This invention relates to “in-the-ear” hearing aids. More particularly, this invention relates to a soft, pliant, and durable hydrogel coating on the earmolds of hearing aids. This coating swells after the hearing aid is inserted in the ear canal and, thus, seals off any pathways for acoustic feedback. The coating also reduces pressure on the ear canal, which renders the hearing aid more comfortable to wear.

Hearing aids function by receiving sound into a microphone and then amplifying that sound through a receiver in the ear canal. U.S. Pat. No. 5,535,282. One common problem experienced by users of “in-the-ear” (ITE) hearing aids is acoustic feedback, which occurs when the sound from the receiver is picked up again by the hearing aid microphone, which results in a squealing sound. Acoustic feedback is caused by a failure to obtain an acoustic seal between the hearing aid earmold and the ear canal. This results in an air gap that allows sound to escape around the earmold back into the microphone.

Many hearing aids are custom-fit to the specific contours of the hearing aid user's ear. U.S. Pat. No. 5,763,503; U.S. Pat. No. 4,814,119. Typically, such hearing aids are fashioned from a molding according to two-stage fitting technology. After a primary mold is made of the hearing aid user's ear canal, a negative mold is made by casting a flexible polymer around the original ear canal mold, which is subsequently removed, leaving a void in the shape of the ear canal. This negative mold is then filled with a photopolymerizable material and exposed to electromagnetic radiation until the outer layer of material has cured in the shape of the surface of the negative mold. The inner volume remains liquid and can be poured out, leaving the earmold with a hollow center. This hollow center is then filled with the electronic components of the hearing aid. In this manner, the hearing aid is specific to the unique shape of the hearing aid user's ear.

Despite the improvements in fitting technology, problems with feedback due to imperfect earmold fit persist. In particular, jaw movement during chewing and talking can cause the shape of the ear canal to change slightly, breaking the acoustic seal.

In view of the foregoing, it will be appreciated that providing a coating for earmolds of ITE hearing aids that reduces or eliminates acoustic feedback and renders the hearing aid more comfortable to the user would be a significant advancement in the art.

### BRIEF SUMMARY OF THE INVENTION

It is a feature of the present invention to provide earmolds for ITE hearing aids that reduce or eliminate acoustic feedback.

It is also a feature of the invention to provide earmolds for ITE hearing aids that are more comfortable to wear than currently available hearing aids.

These and other features and advantages can be addressed by providing an in-the-ear hearing aid comprising:
(a) an earmold body configured for being inserted in an ear canal of a user of the hearing aid and for receiving hearing aid electronics, wherein a portion of the earmold body contacts the ear canal;
(b) the hearing aid electronics disposed in the earmold body; and
(c) a coating comprising a hydrogel disposed on the earmold body such that at least the portion of the earmold body that contacts the ear canal is coated with the hydrogel.

Another illustrative embodiment of the invention comprises an earmold configured for comprising a portion of an in-the-ear hearing aid comprising:
(a) an earmold body configured for being inserted in an ear canal of a user of the hearing aid and for receiving hearing aid electronics, wherein a portion of the earmold body contacts the ear canal; and
(b) a coating comprising a hydrogel disposed on the earmold body such that at least the portion of the earmold body that contacts the ear canal is coated with the hydrogel.

Still another illustrative embodiment of the invention comprises a method for coating an earmold of an in-the-ear hearing aid comprising:
(a) preparing a primary mold of a person's ear canal;
(b) preparing a negative mold from the primary mold;
(c) filling the negative mold at least partly with a hydrogel formulation;
(d) polymerizing the hydrogel formulation for a controlled and sufficient amount of time to form a thin hydrogel layer adjacent to the negative mold and leaving unpolymerized hydrogel formulation distal to the negative mold, and pouring off the unpolymerized hydrogel formulation;
(e) filling the negative mold having the thin hydrogel layer adjacent to the negative mold with an earmold-forming material;
(f) polymerizing the earmold-forming material for a controlled and sufficient amount of time to form aplastic layer adjacent to the thin hydrogel layer on the negative mold and leaving unpolymerized earmold-forming material distal to the thin hydrogel layer, and pouring off the unpolymerized earmold-forming material; and
(g) removing the plastic layer and thin hydrogel layer from the negative mold, thereby obtaining an earmold having a hydrogel coating disposed thereon.

In one illustrative embodiment of this method, the hydrogel layer is about 0.1 to 3 millimeters thick, and the earmold is about 0.5 to 5 millimeters thick.

Yet another illustrative embodiment of the invention comprises a method for making a hearing aid earmold having a hydrogel coating disposed on at least a portion of the earmold comprising:
(a) preparing a primary mold of a person's ear canal;
(b) preparing a negative mold from the primary mold;
(c) forming the earmold using the negative mold and removing the earmold from the negative mold;
(d) disposing a layer of hydrogel formulation on the earmold; and
(e) polymerizing the hydrogel formulation, thereby forming the hydrogel coating.

The hydrogel formulation can be disposed on the earmold by painting, brushing, spraying, or dipping.

### BRIEF DESCRIPTION OF THE SEVERAL VIEWS OF THE DRAWINGS

FIGS. 1A-F show an illustrative fabrication process for a hearing aid earmold having a hydrogel coating disposed thereon.

FIG. 1A shows casting of a negative mold around a primary earmold.

FIG. 1B shows the negative mold with the primary earmold removed.

FIG. 1C shows a hydrogel monomer formulation in the negative mold.

FIG. 1D shows a hydrogel layer in the negative mold after removal of the unpolymerized hydrogel monomer formulation.

FIG. 1E shows conventional earmold material placed in the negative mold for polymerization of the earmold.

FIG. 1F shows the earmold with the hydrogel coating after removal from the negative mold.

FIG. 2 shows a sectional view of a hearing aid earmold wherein a void is carved in the surface of the earmold and then the void is filled with hydrogel to result in a ring of hydrogel around the circumference of the earmold.

### DETAILED DESCRIPTION

Before the present pliant coating for earmolds and methods are disclosed and described, it is to be understood that this invention is not limited to the particular configurations, process steps, and materials disclosed herein as such configurations, process steps, and materials may vary somewhat. It is also to be understood that the terminology employed herein is used for the purpose of describing particular embodiments only and is not intended to be limiting since the scope of the present invention will be limited only by the appended claims and equivalents thereof.

The publications and other reference materials referred to herein to describe the background of the invention and to provide additional detail regarding its practice are hereby incorporated by reference. The references discussed herein are provided solely for their disclosure prior to the filing date of the present application. Nothing herein is to be construed as an admission that the inventors are not entitled to antedate such disclosure by virtue of prior invention.

It must be noted that, as used in this specification and the appended claims, the singular forms “a,” “an,” and “the” include plural referents unless the context clearly dictates otherwise. Thus, for example, reference to a hydrogel containing “a crosslinker” includes a mixture of two ore more of such crosslinkers, reference to “an initiator” includes reference to one or more of such initiators, and reference to “the filler” includes reference to a mixture of two or more of such fillers.

In describing and claiming the present invention, the following terminology will be used in accordance with the definitions set out below.

As used herein, “comprising,” “including,” “containing,” “characterized by,” and grammatical equivalents thereof are inclusive or open-ended terms that do not exclude additional, unrecited elements or method steps. “Comprising” is to be interpreted as including the more restrictive terms “consisting of” and “consisting essentially of.”

As used herein, “consisting of” and grammatical equivalents thereof exclude any element, step, or ingredient not specified in the claim.

As used herein, “consisting essentially of” and grammatical equivalents thereof limit the scope of a claim to the specified materials or steps and those that do not materially affect the basic and novel characteristic or characteristics of the claimed invention.

The present invention creates an acoustic seal that responds to the short-term changes in the ear canal shape due to jaw movement. This is accomplished through an earmold that is at least partially covered by a thin hydrogel coating. Hydrogels are crosslinked three-dimensional polymer networks that swell in aqueous solutions. Upon wetting, the hydrogels undergo transition from a compact glassy phase to an expanded and pliant rubbery phase. Thus, when the earmold is placed into the ear, the coating is relatively thin and hard. Upon contact with moisture in the ear, however, the coating absorbs moisture, swells in size, and increases in flexibility, allowing it to create a pliant acoustic seal with the skin inside the ear canal. The dynamic elastomeric properties of the hydrogel maintain the acoustic seal even during short-term changes in the ear canal shape. In an alternative application, the hydrogel coating can be wetted immediately prior to placement in the ear.

The present invention solves two problems: acoustic feedback and pressure on the ear canal. The soft, flexible, rubbery hydrogel coating exerts less pressure on the ear canal than the hard acrylic polymers that make up traditional earmolds. After removal from the ear canal, the hydrogel coating shrinks back to its original compact glassy phase upon drying.

The hydrogel coating is comprised of at least a hydrogel monomer, a cross-linker, and an initiator. In some embodiments fillers, foam stabilizing surfactants, foaming agents, or viscosity modifiers may also be included.

Generally, hydrogel monomers include water soluble monomers that, when polymerized, form hydrogel polymers. These polymers absorb water and swell, thus forming the hydrogel. The monomers that can be used according to the present invention are limited only by functionality. Illustrative categories of hydrogel monomers include hydroxyalkyl acrylates and hydroxyalkyl methacrylates. Illustrative examples of specific hydrogel monomers that can be used according to the present invention include 2-hydroxyethyl methacrylate (HEMA), 2-hydroxyethyl acrylate, N-vinyl pyrrolidone (NVP), methacrylic acid (MAA) and salts thereof, acrylic acid and salts thereof, vinyl acetate, hydroxypropyl methacrylate, and the like, and mixtures thereof.

Crosslinkers that can be used according to the present invention include polymerizable molecules that can form a link between two or more polymer chains. Crosslinkers are well known in the art, and crosslinkers that can be used in the present invention are limited only by functionality. Illustrative categories of crosslinkers include diacrylates, dimethacrylates, and diacrylamides. Illustrative crosslinkers include ethylene glycol dimethacrylate (EGDMA), ethylene glycol diacrylate, poly(ethylene glycol)dimethacrylate (PEGDMA), poly(ethylene glycol)diacrylate, N,N′-methylenebisacrylamide, and the like, and mixtures thereof.

Initiators are used in making the hydrogels of the present invention for initiating and assisting in controlling the polymerization reaction. Such initiators can include, for example, photoinitiators, such as those that are activated by ultraviolet (UV), visible, or X-ray radiation; thermal initiators; and redox-radical initiator systems. Initiators that can be used according to the present invention are limited only by functionality. Illustrative categories of initiators that can be used in the present invention include benzoin ethers, phenyl ketones, phosphine oxides, acetophenones, thioxanthones, camphorquinones, ketocoumarins, peroxides, persulfates, azo compounds, and the like, and mixtures thereof. Illustrative initiators that can be used according to the present invention include benzophenone, benzoin ethyl ether (BEE), 2,2-dimethoxy-2-phenyl-acetophenone, benzoyl cyclohexanol, p hydroxybenzophenone, and ammonium persulfate together with N,N,N′,N′-tetramethylethylenediamine as a catalyst.

In a typical embodiment, a UV photoinitiator is used to polymerize the hydrogel coating. The photoinitiator can initiate polymerization by generation of free radicals or ionic molecules. Preferred photoinitiators include acetophenones such as benzoin ethyl ether (BEE) or 2,2-dimethoxy-2-phenyl-acetophenone, but any photoinitiator may be used that is suitable for the wavelength of light used in the photopolymerization process.

Fillers used in the present invention include inorganic insoluble materials that absorb or block light. Illustrative categories of fillers according to the present invention include metal oxides, silicon oxides, and insoluble carbonates, sulfates, phosphates, and the like, and mixtures thereof. Illustrative fillers include titanium dioxide, fumed silica, calcium carbonate, and silicon dioxide, such as ground sand or glass.

Foam stabilizing surfactants that can be used in the present invention include any surface active molecule that stabilizes the interface between a gas bubble and a liquid. Illustrative categories of surfactants include polyether diblock copolymers, polyether triblock copolymers, non-ionic surfactants, anionic surfactants, and cationic surfactants. Such surfactants are limited only by functionality. Illustrative surfactants include PLURONIC F127, PLURONIC P108, PLURONIC P105, sodium dodecyl sulfate, TRITON X-100, ZONYL FJS, MERPOL SH, and the like, and mixtures thereof. The PLURONIC series of surfactants (BASF) are ABA triblock copolymers having the structure poly(oxyethylene)-poly(oxypropylene)-poly(oxyethylene). These surfactants comprise about 10-80% by weight of poly(oxyethylene), and the poly(oxypropylene) component has a molecular weight of about 9504,000. Typical PLURONIC surfactants used in the present invention comprise about 60-80% by weight of poly(oxyethylene), and the poly(oxypropylene) component has a molecular weight of about 2,5004,000.

Foaming agents used in the present invention include chemical systems that release gas upon change in pH, temperature, or pressure. Illustrative categories of foaming agents include alkali bicarbonates, alkali carbonates, fluorocarbon gases, and pressurized gases, such as pressurized carbon dioxide. Illustrative foaming agents include sodium bicarbonate, sodium carbonate, and the like, and mixtures thereof.

Viscosity modifiers can be added to the hydrogel formulation to assist in the application of the hydrogel to an existing hearing aid earmold. For example, to apply a hydrogel by brushing it onto a hearing aid earmold, it is helpful and useful if the unpolymerized formulation has a viscosity sufficient that it will not run off the earmold before the hydrogel is polymerized in place. In general, any polymer that is soluble in the monomer formulation and increases the viscosity of the formulation can be used. Illustrative categories of viscosity modifiers include vinyl polymers, polyethers, acrylic polymers, and the like, and mixtures thereof. Illustrative viscosity modifiers include poly(N-vinyl pyrrolidone), poly(hydroxyethyl methacrylate), poly(vinyl alcohol), poly(ethylene oxide), poly(methyl methacrylate), poly(vinyl chloride), and poly(vinyl acetate). For example, poly(N-vinyl pyrrolidone) can be added to the hydrogel monomer formulation in amounts generally in the range of about 0 to 10% by weight, typically in the range of about 2 to 6% by weight, and illustratively about 4% by weight.

Another method for increasing viscosity of the hydrogel monomer formulation is to partially polymerize the formulation, such as with short exposure to UV radiation in those formulations containing a UV photoinitiator. The UV exposure should be for a time sufficient to increase the viscosity of the formulation, but for a short enough time that the formulation remains liquid, albeit a more viscous liquid than before partial polymerization.

It has also been discovered that adding water or an aqueous solvent to the hydrogel monomer formulation results in a hydrogel having excellent swelling properties. Water can be added to the formulation in amounts ranging from about 0 to 50% by weight of the total formulation. Typically the formulation can contain about 1 to 10% by weight of water.

An excellent earmold coating can be obtained with a mixture of HEMA and NVP as hydrogel monomers. These monomers can be present in mole ratios from about 100/0 to 10/90, more typically from about 80/20 to 60/40, and optimally about 70/30. Some hydrogels will develop cracks after repeated cycles of hydration and drying. Hydrogels containing HEMA/NVP in a mole ratio of about 70/30, however, resist cracking to a large extent. The crosslinker used in an excellent embodiment of the invention comprises poly(ethylene glycol)dimethacrylate, generally in the range of about 0.25 to 10% by weight, more typically about 0.75 to 2% by weight, and optimally about 1% by weight. The initiator used in an excellent embodiment of the invention comprises the photoinitiator, 2,2-dimethoxy-2-phenylacetophenone, generally in the range of about 0.25 to 5% by weight, more typically about 0.4 to 2% by weight, and optimally about 0.5% by weight. The filler used in an excellent embodiment of the invention comprises titanium dioxide, silicon dioxide, or mixtures thereof in amounts generally ranging up to about 5% by weight, but more typically up to about 1% by weight. A foaming agent and a foam stabilizing agent used in an excellent embodiment of the invention comprise, respectively, sodium bicarbonate and PLURONIC F127.

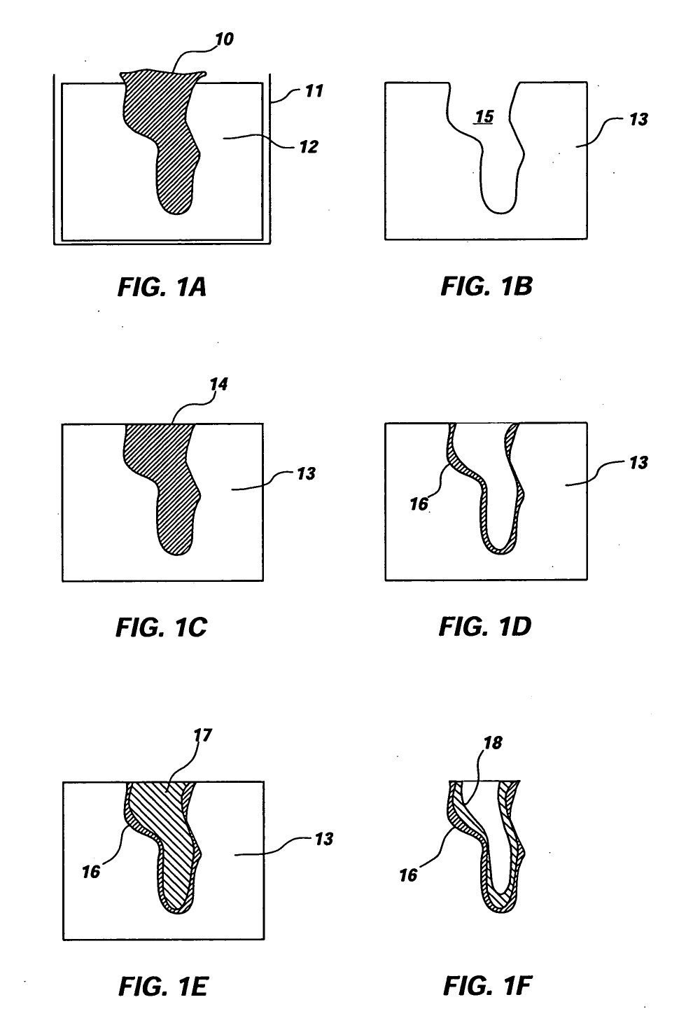

FIGS. 1A-F show an example of a procedure for making an earmold, at least a portion of which is coated with a hydrogel coating. A primary mold 10 of the ear canal is made by conventional and known practices by an audiologist or other person skilled in this art. The primary mold is placed in a flexible rubber cup 11 and a clear commercial silicone rubber 12 is poured around the primary mold (FIG. 1A). After the silicone rubber has cured, the primary mold 10 of the ear canal is removed and the silicone “negative” mold 13 is removed from the rubber cup (FIG. 1B). This mold making technology is currently known and practiced by those skilled in the art.

To practice the novel technology presented herein, one mixes together the hydrogel monomers, crosslinkers, photoinitiators and fillers into a free-flowing solution. If needed, a solvent (water, alcohol, tetrahydrofuran) may be added to reduce the viscosity. The solution 14 is then poured into the void 15 formed in the negative mold (FIG. 1C). If it is desired to create a hydrogel coating over the complete earmold, the negative mold is filled completely. If it is desired to coat only the distal end of the earmold, however, then the negative mold is only partly filled with the solution. Then the mold is placed in a chamber containing UV light which exposes the bottom and sides of the mold for a controlled amount of time. Because the UV light penetrates the clear silicone rubber mold and enters the monomer solution 14 from the sides and bottom, the monomer adjacent to the silicone mold polymerizes first, forming a crosslinked hydrogel shell 16 adjacent to the silicone mold 13 and leaving the monomer in the interior unpolymerized. One of the purposes of the filler is to block UV light from penetrating and polymerizing too far into the solution. The thickness of this polymerized shell 16 increases with exposure time, and therefore the time of exposure must be carefully controlled to obtain the desired thickness of the hydrogel shell 16. The exposure time will depend on the wavelength and intensity of the UV light, the position of the UV lights, the geometry of the exposure chamber, the type of monomer, and the concentration of initiator and filler. A person skilled in the art can readily manipulate these factors to obtain a hydrogel of a selected thickness without undue experimentation.

After the hydrogel shell 16 is polymerized to the desired thickness, the mold is removed from the UV chamber and the unpolymerized solution in the central volume is poured off, leaving the hydrogel shell 16 attached to the negative mold (FIG. 1D).

Next, a mixture 17 of acrylic monomers, photoinitiators, fillers and pigments is poured into the remaining space within the hydrogel shell 16 in the negative mold (FIG. 1E). The mold is placed back in the UV chamber and exposed to UV light for a controlled amount of time. The UV light penetrates the silicone mold 13, the hydrogel shell 16, and polymerizes a shell 18 of acrylic polymer. Again the thickness of the acrylic shell 18 is controlled by the time of exposure, and when the desired thickness is attained, the mold is removed from the UV chamber and the unpolymerized liquid is poured off, leaving a hollow acrylic shell 18, or earmold with a hydrogel coating 16 on at least a portion of the earmold (FIG. 1F). The electronic components of the hearing aid are placed in the earmold and the outer surface of the earmold and hydrogel coating may be polished and prepared for the user.

The novel properties of the hydrogel coating are realized when the user places the coated earmold in the ear. Initially the coating is hard and thin, enabling the earmold to slide easily into the ear. As it contacts the moisture inside the ear canal, the coating begins to absorb the moisture and swells, becoming both thicker and softer, or more pliant. In an illustrative embodiment, the earmold and coating are polished to a size slightly smaller than the ear canal for ease of insertion. The thickness of the hydrogel coating is designed and prepared so that is swells just enough to make a firm contact with the skin of the ear canal. The soft pliant nature avoids hard pressure contact with the ear canal. The flexible nature allows the hydrogel to conform to changes in shape of the ear canal during talking or chewing, thus maintaining the acoustic seal and preventing acoustic feedback.

At the end of the day the earmold (and the hearing aid inside) is removed and placed on a dry surface overnight. The absorbed moisture evaporates during the night, and thus the hydrogel shrinks, and the earmold is ready to be inserted again the next day. In humid environments, the earmold can be placed in a drying chamber.

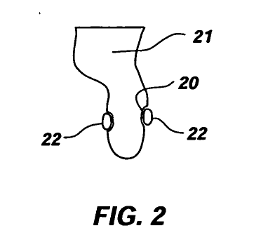

In an alternative embodiment the pliant coating does not necessarily need to completely coat the earmold, but need only coat a sufficient area to form an acoustic seal within the ear canal. For example, as shown in FIG. 2, an annular ring-shaped void 20 could be carved into a conventional earmold 21 made from conventional materials. Then the void 20 can be filled with the hydrogel formulation and the material polymerized to form a ring of pliant hydrogel 22 around the earmold. The hydrogel formulation can be painted on by hand, or poured into the annular void formed between the carved out earmold and the silicone rubber negative mold, before being polymerized by UV light. When the ring of hydrogel is moistened after insertion into the ear, the ring swells and contacts the ear canal, again forming an acoustic seal to eliminate feedback.

In still another illustrative embodiment, the hydrogel does not need to be a continuous and solid material, but need only contain internal pores that connect to the surface, the purpose of which is to provide channels to conduct or to wick the moisture in the ear canal quickly into the hydrogel so it can swell faster. There are many ways to form pores in hydrogels. One common method is to add a foaming agent to the hydrogel formulation such that the hydrogel contains gas bubbles at the time it is polymerized. The addition of sodium bicarbonate reacts with acid groups in the hydrogel formulation to produce carbon dioxide gas bubbles. These gas bubbles can be stabilized so that they do not coalesce, but instead remain small during the time of polymerization. A common stabilizing material is a block copolymer surfactant such as PLURONIC F127 (BASF). Many other PLURONIC surfactants, block copolymer surfactants, or non-polymeric surfactants can be used and are well known to those skilled in the art.

Another method of forming pores is to add a powdered solid, such as salt or sugar, that does not dissolve in the hydrogel formulation, but that is dissolved out later after polymerization by placing the coated earmold in water. The salt or sugar dissolves away into the water, leaving pores behind. The earmold can then be dried, and the pores remain in the hydrogel coating so that when the earmold is inserted into the ear canal, the moisture present quickly wicks into the hydrogel coating and cause the coating to swell rapidly into a thicker and softer material.

There a many other methods that can be practiced by one skilled in the art to cover with a hydrogel at least a portion of the earmold sufficiently to form an acoustic seal with the ear canal. These examples presented herein are not limiting in any sense, but are only exemplary for purposes of illustration and teaching.

1. An in-the-ear hearing aid comprising:
(a) an earmold body configured for being inserted in an ear canal of a user of the hearing aid and for receiving hearing aid electronics, wherein a portion of the earmold body contacts the ear canal;
(b) the hearing aid electronics disposed in the earmold body, and
(c) a coating comprising a hydrogel disposed on the earmold body such that at least the portion of the earmold body that contacts the ear canal is coated with the hydrogel.

2. The hearing aid of claim 1 wherein the hydrogel expands as a soft pliant phase upon absorbing moisture and shrinks to a compact glassy phase upon drying.

3. The hearing aid of claim 2 wherein the hydrogel is polymerized from a mixture comprising a hydrogel monomer, a crosslinker, and an initiator.

4. The hearing aid of claim 3 wherein the initiator is a member selected from the group consisting of benzoin ethers, phenyl ketones, phosphine oxides, acetophenones, thioxanthones, camphorquinones, ketocoumarins, peroxides, persulfates, azo compounds, and mixtures thereof.

5. The hearing aid of claim 3 wherein the initiator is a member selected from the group consisting of benzophenone, benzoin ethyl ether, 2,2, dimethoxy-2-phenyl-acetophenone, benzoyl cyclohexanol, p-hydroxybenzophenone, ammonium persulfate, and mixtures thereof.

6. The hearing aid of claim 3 wherein the initiator comprises a photoinitiator.

7. The hearing aid of claim 6 wherein the photoinitiator comprises an acetophenone.

8. The hearing aid of claim 7 wherein the acetophenone comprises 2,2-dimethoxy-2-phenyl-acetophenone.

9. The hearing aid of claim 3 wherein the mixture further comprises a foaming agent.

10. The hearing aid of claim 9 wherein the foaming agent is a member selected from the group consisting of alkali bicarbonates, alkali carbonates, fluorocarbon gases, pressurized gases, and mixtures thereof.

11. The hearing aid of claim 9 wherein the foaming agent comprises sodium bicarbonate.

12. The hearing aid of claim 3 wherein the mixture further comprises a foam stabilizing surfactant.

13. The hearing aid of claim 12 wherein the foam stabilizing surfactant is a member selected from the group consisting of polyether diblock copolymers, polyether triblock copolymers, non-ionic surfactants, anionic surfactants, cationic surfactants, and mixtures thereof.

14. The hearing aid of claim 12 wherein the foam stabilizing surfactant comprises an amphiphilic block copolymer.

15. The hearing aid of claim 14 wherein the amphiphilic block copolymer is an ABA triblock copolymer.

16. The hearing aid of claim 15 wherein the ABA triblock copolymer comprises a polyoxyethylene-polyoxypropylene-polyoxyethylene copolymer.

17. The hearing aid of claim 16 wherein the polyoxyethylene-polyoxypropylene-polyoxyethylene copolymer comprises about 60 to 80% by weight of polyoxyethylene.

18. The hearing aid of claim 16 wherein the polyoxyethylene-polyoxypropylene-polyoxyethylene copolymer comprises a polyoxypropylene block having a molecular weight of about 2500 to 4000.

19. The hearing aid of claim 3 wherein the mixture further comprises a filling agent.

20. The hearing aid of claim 19 wherein the filling agent is a member selected from the group consisting of metal oxides, silicon oxides, water-insoluble carbonates, water-insoluble sulfates, water-insoluble phosphates, and mixtures thereof.

21. The hearing aid of claim 19 wherein the filling agent comprises titanium dioxide.

22. The hearing aid of claim 19 wherein the filling agent comprises silicon dioxide.

23. The hearing aid of claim 19 wherein the filling agent comprises fumed silica.

24. The hearing aid of claim 19 wherein the filling agent comprises calcium carbonate.

25. The hearing aid of claim 3 wherein the mixture further comprises a foaming agent, foam stabilizing surfactant, filling agent, or mixture thereof.

26. The hearing aid of claim 3 wherein the hydrogel monomer is a member selected from the group consisting of hydroxyalkyl methacrylates, hydroxyalkyl acrylates, and mixtures thereof.

27. The hearing aid of claim 3 wherein the hydrogel monomer is a member selected from the group consisting of 2-hydroxyethyl methacrylate, 2-hydroxyethyl acrylate, N-vinyl pyrrolidone, methacrylic acid and salts thereof, acrylic acid and salts thereof, vinyl acetate, hydroxypropyl methacrylate, and mixtures thereof.

28. The hearing aid of claim 3 wherein the hydrogel monomer comprises 2-hydroxyethyl methacrylate.

29. The hearing aid of claim 3 wherein the hydrogel monomer comprises methacrylic acid.

30. The hearing aid of claim 3 wherein the hydrogel monomer comprises N-vinyl pyrrolidone.

31. The hearing aid of claim 3 wherein the crosslinker is a member selected from the group consisting of diacrylates, dimethacrylates, diacrylamides, and mixtures thereof.

32. The hearing aid of claim 3 wherein the crosslinker is a member selected from the group consisting of ethylene glycol dimethacrylate, ethylene glycol diacrylate, poly(ethylene glycol)dimethacryate, poly(ethylene glycol)diacrylate, N,N′-methylenebisacrylamide, and mixtures thereof.

33. The hearing aid of claim 3 wherein the crosslinker comprises a diacrylate.

34. The hearing aid of claim 33 wherein the diacrylate comprises ethylene glycol dimethacrylate.

35. An earmold configured for comprising a portion of an in-the-ear hearing aid comprising:
(a) an earmold body configured for being inserted in an ear canal of a user of the hearing aid and for receiving hearing aid electronics, wherein a portion of the earmold body contacts the ear canal; and
(b) a coating comprising a hydrogel disposed on the earmold body such that at least the portion of the earmold body that contacts the ear canal is coated with the hydrogel.

36. The earmold of claim 35 wherein the hydrogel expands as a soft pliant phase upon absorbing moisture and shrinks to a hard glassy phase upon drying.

37. The earmold of claim 36 wherein the hydrogel is polymerized from a mixture comprising a hydrogel monomer, a crosslinker, and an initiator.

38. The earmold of claim 37 wherein the initiator is a member selected from the group consisting of benzoin ethers, phenyl ketones, phosphine oxides, acetophenones, thioxanthones, camphorquinones, ketocoumarins, peroxides, persulfates, azo compounds, and mixtures thereof.

39. The earmold of claim 37 wherein the initiator is a member selected from the group consisting of benzophenone, benzoin ethyl ether, 2,2, dimethoxy-2-phenyl-acetophenone, benzoyl cyclohexanol, p-hydroxybenzophenone, ammonium persulfate, and mixtures thereof.

40. The earmold of claim 37 wherein the initiator comprises a photoinitiator.

41. The earmold of claim 40 wherein the photoinitiator comprises an acetophenone.

42. The earmold of claim 41 wherein the acetophenone comprises 2,2-dimethoxy-2-phenyl-acetophenone.

43. The earmold of claim 37 wherein the mixture further comprises a foaming agent.

44. The earmold of claim 43 wherein the foaming agent is a member selected from the group consisting of alkali bicarbonates, alkali carbonates, fluorocarbon gases, pressurized gases, and mixtures thereof.

45. The earmold of claim 43 wherein the foaming agent comprises sodium bicarbonate.

46. The earmold of claim 37 wherein the mixture further comprises a foam stabilizing surfactant.

47. The earmold of claim 46 wherein the foam stabilizing surfactant is a member selected from the group consisting of polyether diblock copolymers, polyether triblock copolymers, non-ionic surfactants, anionic surfactants, cationic surfactants, and mixtures thereof.

48. The earmold of claim 46 wherein the foam stabilizing surfactant comprises an amphiphilic block copolymer.

49. The earmold of claim 48 wherein the amphiphilic block copolymer is an ABA triblock copolymer.

50. The earmold of claim 49 wherein the ABA triblock copolymer comprises a polyoxyethylene-polyoxypropylene-polyoxyethylene copolymer.

51. The earmold of claim 50 wherein the polyoxyethylene-polyoxypropylene-polyoxyethylene copolymer comprises about 60 to 80% by weight of polyoxyethylene.

52. The earmold of claim 50 wherein the polyoxyethylene-polyoxypropylene-polyoxyethylene copolymer comprises a polyoxypropylene block having a molecular weight of about 2500 to 4000.

53. The earmold of claim 37 wherein the mixture further comprises a filling agent.

54. The earmold of claim 53 wherein the filling agent is a member selected from the group consisting of metal oxides, silicon oxides, water-insoluble carbonates, water-insoluble sulfates, water-insoluble phosphates, and mixtures thereof.

55. The earmold of claim 53 wherein the filling agent comprises titanium dioxide.

56. The earmold of claim 53 wherein the filling agent comprises silicon dioxide.

57. The earmold of claim 53 wherein the filling agent comprises fumed silica.

58. The earmold of claim 53 wherein the filling agent comprises calcium carbonate.

59. The earmold of claim 37 wherein the mixture further comprises a foaming agent, foam stabilizing surfactant, filling agent, or mixture thereof.

60. The earmold of claim 37 wherein the hydrogel monomer is a member selected from the group consisting of hydroxyalkyl methacrylates, hydroxyalkyl acrylates, and mixtures thereof.

61. The earmold of claim 37 wherein the hydrogel monomer is a member selected from the group consisting of 2-hydroxyethyl methacrylate, 2-hydroxyethyl acrylate, N-vinyl pyrrolidone, methacrylic acid and salts thereof, acrylic acid and salts thereof, vinyl acetate, hydroxypropyl methacrylate, and mixtures thereof.

62. The earmold of claim 37 wherein the hydrogel monomer comprises 2-hydroxyethyl methacrylate.

63. The earmold of claim 37 wherein the hydrogel monomer comprises methacrylic acid.

64. The earmold of claim 37 wherein the hydrogel monomer comprises N-vinyl pyrrolidone.

65. The earmold of claim 37 wherein the crosslinker is a member selected from the group consisting of diacrylates, dimethacrylates, diacrylamides, and mixtures thereof.

66. The earmold of claim 37 wherein the crosslinker is a member selected from the group consisting of ethylene glycol dimethacrylate, ethylene glycol diacrylate, poly(ethylene glycol)dimethacryate, poly(ethylene glycol)diacrylate, N,N′-methylenebisacrylamide, and mixtures thereof.

67. The earmold of claim 37 wherein the crosslinker comprises a diacrylate.

68. The earmold of claim 67 wherein the diacrylate comprises ethylene glycol dimethacrylate.

69. A method for coating an earmold of an in-the-ear hearing aid comprising:
(a) preparing a primary mold of a person's ear canal;
(b) preparing a negative mold from the primary mold;
(c) filling the negative mold at least partly with a hydrogel formulation;
(d) polymerizing the hydrogel formulation for a controlled and sufficient amount of time to form a thin hydrogel layer adjacent to the negative mold and leaving unpolymerized hydrogel formulation distal to the negative mold, and pouring off the unpolymerized hydrogel formulation;
(e) filling the negative mold having the thin hydrogel layer adjacent to the negative mold with an earmold-forming material;
(f) polymerizing the earmold-forming material for a controlled and sufficient amount of time to form a plastic layer adjacent to the thin hydrogel layer on the negative mold and leaving unpolymerized earmold-forming material distal to the thin hydrogel layer, and pouring off the unpolymerized earmold-forming material; and
(g) removing the plastic layer and thin hydrogel layer from the negative mold, thereby obtaining an earmold having a hydrogel coating disposed thereon.

70. The method of claim 70, wherein the hydrogel layer is about 0.1 to 3 millimeters thick.

71. The method of claim 69 wherein the earmold is about 0.5 to 5 millimeters thick.

72. A method for making a hearing aid earmold having a hydrogel coating disposed on at least a portion of the earmold comprising:
(a) preparing a primary mold of a person's ear canal;
(b) preparing a negative mold from the primary mold;
(c) forming the earmold using the negative mold and removing the earmold from the negative mold;
(d) disposing a layer of hydrogel formulation on the earmold; and
(e) polymerizing the hydrogel formulation, thereby forming the hydrogel coating.

73. The method of claim 72 wherein the earmold comprises a void for receiving the hydrogel formulation.

74. The method of claim 73 wherein the hydrogel formulation is disposed on the earmold by painting, brushing, spraying, or dipping.
